(19) United States
(12) Patent Application Publication
(10) Pub. No.: US 2023/0150376 A1
(43) Pub. Date: May 18, 2023

(54) Vehicle Backup Battery

(71) Applicant: Renato DeCastro, Hudson, NH (US)

(72) Inventor: Renato DeCastro, Hudson, NH (US)

(21) Appl. No.: 17/528,464

(22) Filed: Nov. 17, 2021

(51) Int. Cl. B60L 53/18; B60L 50/60; B60L 53/80; B60L 58/12; B60K 1/04

(52) U.S. Cl. CPC B60L 53/18; B60L 50/66; B60L 53/80; B60L 58/12; B60K 1/04; B60K 2001/0477; B60K 2001/0494; B60K 2001/0416

(57) ABSTRACT

An electric vehicle backup battery is provided. The back up battery is removably positionable within an interior or the vehicle and can operate to directly power the vehicle, or charge a primary battery of the vehicle, if and when the primary battery runs out of charge, to allow the electric vehicle to reach a charging source.

### BACKGROUND

### Technical Field

The present disclosure relates generally to batteries. More particularly the present disclosure relates to a backup battery for electric vehicles which is removably stored in a vehicle and which can provide backup power through direct connection or through a connection to the electric vehicle charge port.

### Description of Related Art

Electric vehicles (“EVs”) are rapidly becoming ubiquitous and are predicted to rapidly replace internal combustion engine vehicles over the coming years. These vehicles utilize large battery packs to store energy and drive the motor or motors, rather than gasoline in a tank.

One problem with EVs is that in many instances they have a limited range, and charging stations are far less ubiquitous than gas stations, making it harder to easily find charging options when running low on charge. This can lead to running out of charge and a stuck vehicle. While this happens with gasoline vehicles sometimes, there is a greater concern with electric vehicles due to limited range and fewer charging option.

It is also more inconvenient when an EV runs out of charge than when an internal combustion vehicle runs out of fuel. When an internal combustion vehicle runs out of fuel, a small quantity of fuel can be delivered, poured into the tank, and the vehicle can be driven off. However, when an EV runs out of charge, one must bring a fuel based generator (gas, etc.) to generate electricity to charge the battery. This is both inconvenient and slow because one must wait for the battery to charge up enough to drive to a home or charge station.

Therefore, what is needed is a system which can more efficiently provide backup charge or supplemental charge to EVs.

### SUMMARY

The subject matter of this application may involve, in some cases, interrelated products, alternative solutions to a particular problem, and/or a plurality of different uses of a single system or article.

In one aspect, an electric vehicle is provided. The electric vehicle has a frame, a body connected to the frame which defines an interior space for passengers and storage space, and a primary battery connected to at least one of the frame and the body. The primary battery is in electrical communication with at least one motor operable to rotate at least one of the plurality of wheels. The electric vehicle also has a charge port operable to receive an electrical connection to charge the primary battery. Further, the electric vehicle includes a backup battery removably connected to the electric vehicle, the backup battery having a charge capacity that is less than a charge capacity of the primary battery. The backup battery may have a case on an outside to define a body of the battery, as well as an electrical connector allowing an electronic communication of the backup battery with the electric vehicle. Further, a cord extends from the case, the cord allows for connection of the backup battery with a second different vehicle to charge a battery of the second different vehicle. The backup battery is removably connectable in the storage space. When the backup battery is in a connected position, the backup battery electrical connector engaged with a corresponding electrical connector in the vehicle storage space, the corresponding vehicle electrical connector in electronic communication with at least one of the primary battery and the at least one motor to cause a rotation of at least one of the plurality of wheels. A switch allows activation of the backup battery, and a vehicle computer operates to monitor a state of charge of both the primary battery and the backup battery, and can display this on a visual display of the vehicle.

In another aspect, a method of operation of an electric vehicle backup battery is provided. The method involves charging the backup battery using a wall outlet, the backup battery having a cord and plug for connection of the battery to the wall outlet. The method also includes positioning the backup battery into an electric vehicle, the step of positioning the backup battery comprising engaging an electrical connector of the backup battery with an electrical connector of the electric vehicle positioned within the electric vehicle. The backup battery may be removed from the vehicle. Further, the backup battery may be used for charging a second different electric vehicle by connecting a charging cord of the backup battery to a charge port of the second different electric vehicle.

### BRIEF DESCRIPTION OF THE DRAWINGS

FIG. 1 provides a flow chart of an embodiment of operation of the present disclosure.

FIG. 2 provides a provides a perspective view of an embodiment of a vehicle trunk or storage area having an embodiment of the backup battery of the present disclosure therein.

FIG. 3 provides a view of an embodiment of a backup battery of the present disclosure.

FIG. 4 provides a provides a perspective view of an embodiment of a vehicle trunk or storage area having an embodiment of the backup battery of the present disclosure therein.

FIG. 5 provides an embodiment of the present disclosure.

FIG. 6 provides a detail view of a connection of backup battery to vehicle of an embodiment of the present disclosure.

FIG. 7 provides a detail view of a connection of backup battery to vehicle of an embodiment of the present disclosure.

FIG. 8 provides an embodiment of the present disclosure in one mode of operation.

FIG. 9 provides a flow chart of another embodiment of operation of the present disclosure.

FIG. 10 provides a flow chart of yet another embodiment of operation of the present disclosure.

FIG. 11 provides a detail view of a connection of backup battery to vehicle of another embodiment of the present disclosure.

FIG. 12 provides a detail view of a connection of backup battery to vehicle of yet another embodiment of the present disclosure.

### DETAILED DESCRIPTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a backup battery system for electric vehicles (“EVs”). The system involves a battery pack operable to be removably secured in the vehicle, such that it can directly operate the vehicle it is in in a first operational mode, and having a secondary charging cord to provide electric power to another separate vehicle in a second operational mode.

An EV, as disclosed herein, typically has a vehicle frame, and a body connected to the frame which defines an interior space for passengers. The vehicle has a plurality of wheels, at least one of which can be rotated by at least one motor, with the motor(s) being powered by a primary battery which is connected to at least one of the frame and/or the body. The EV further has a charge port which is accessible from inside or outside the vehicle and which can receive an electrical connection to charge the primary battery. Further, the EV of this disclosure includes a backup battery which has a charge capacity that is less than a charge capacity of the primary battery. This backup battery is operable to provide an amount of charge which is sufficient to allow the vehicle to drive a limited amount of miles further to reach a charging source to recharge the primary battery in the event that the primary battery has run out of power. In various modes of operation, the backup battery may allow the vehicle to drive at a low speed using only minimal power to maximize range. Further, depending on embodiment, the backup battery may charge the primary battery which in turn may drive the vehicle, or the backup battery may directly drive the motors itself.

In one embodiment, a manually operated switch may be positioned in the vehicle or in a storage space such as a rear hatch or trunk of the vehicle which can activate the backup battery. In another embodiment, this switch may be actuated through an input into the EV's computerized control interface. In still another embodiment, the backup battery may automatically activate upon a decrease of the primary battery below a predetermined threshold. However, in many cases, a manually operated switch is preferred because it deters a driver from driving the primary battery too low on charge, it prevents accidental or frequent use by making the actuation more deliberate, and perhaps most importantly acts as a fail safe: if the primary battery is completely dead, the computerized actuation may not be possible because there will be no electricity to cause switch actuation.

The backup battery may be any type of battery capable of storing electricity. In one embodiment, the backup battery may be a lithium-ion battery due to its light weight and reliability. In another embodiment, the backup battery may be a lead acid battery due to its ability to hold a charge for a long time, reliability, and durability. Depending on the vehicle and vehicle needs, battery size and capacity may vary greatly. In most embodiments, the battery must be small enough that it can be removed from the vehicle by a person without injuring themselves, but also powerful enough to be able to drive the vehicle a sufficient distance. In various embodiments, the backup battery may be sized to provide between approximately 5, 10, 15, 20, and 25 miles of range. Of course, in other embodiments, range may be greater than this. Depending on the EV, this will result in a backup battery pack sized anywhere between 1.5-7.5 kwh, and in some embodiments up to 10 kwh.

In a particular embodiment, the EV may be operable-typically by a computer controller such as a chip- to charge the backup battery to 100% state of charge and hold it at 100% state of charge. In many cases, charging to 100% on certain batteries puts a strain on the battery and can lead to degradation over time. However, because the backup battery is a removable and replaceable, degradation is less of a concern and a maximum charge to allow emergency driving is a higher priority and therefore typically preferred.

In one embodiment, the backup battery may be charged preferentially to the primary battery when charging the vehicle. In other words, the EV computer may be operable to first charge the backup battery to predetermined state of charge (in many embodiments, 100% or close to it), and then once that is charged, the primary battery is charged. In another embodiment, the charge port charges the primary battery, and the primary battery in turn charges the backup battery. In yet another embodiment, the EV computer may be operable to monitor a state of charge of the backup battery and operable to cause the primary battery to charge the backup battery, even when not plugged in, if the backup battery drops below a certain state of charge, such as 90% or 95% for example. Of course, other embodiments of different charge configurations, such as partially charging both simultaneously, and the like, are also within the scope of this disclosure.

The backup battery is, in many embodiments, intended to be removable so that it can also be used to charge another vehicle. In one embodiment, the EV may be specifically designed with a well or port, or other storage space in the vehicle specifically sized and designed to receive the backup battery. This storage area for the backup battery may, in one embodiment, have an electrical connector which corresponds to an electrical connector on the backup battery. As such, when the battery pack is positioned in the storage space, it is automatically electrically connected to the vehicle. The electrical connectors may be electric contacts such as mating male and female plugs, metal strips, and the like. The male end of the plug can be on either the battery pack or vehicle, with the matching female plug on the other of the two. In some embodiments, the male side of the plug is retractable such that it only extends outwardly when the opposing plug is nearby. Structures such as magnets, springs, pistons, electric actuators, prongs, protrusions, levers, switches and the like may all be used to cause the male plug to extend from and retract to its retracted position. As such, the EV of the present disclosure is specifically designed to receive and engage with the backup battery of the present disclosure.

In certain embodiments, a well or other storage area in the vehicle for the backup battery pack may include a guide slot, channel, rail, or the like to aid in proper positioning of the backup battery to engage electrical contacts of the backup battery and vehicle. In a particular embodiment, the guide slot may have a catch or protrusion which can cause a retractable connector in either the backup battery pack or vehicle to engage and connect to a matching female connector on the other of the battery and vehicle.

In some embodiments, a cover, strap, or case, or similar structure can extend over the backup battery when attached to the vehicle to prevent it from being dislodged and to prevent accidental contacting or other interference with the backup battery by other items in the truck or vehicle storage area.

In one embodiment, the backup battery has a cord on its exterior or case. This cord is connected to the battery and has a plug on a distal end which allows it to directly connect to a charge port of a second, different EV. This configuration allows the backup battery to not only operate the EV in which it is installed, but it can also provide charge to a second EV through this cord by plugging into the second EV's charge port.

In a particular embodiment, the EV may further have an extending arm which can move or aid in moving the backup battery between an inside and outside of the vehicle. In a further embodiment, the extending arm may also move downward to the ground to lower the backup battery pack. In many cases, the backup battery is positioned somewhat deep inside the vehicle trunk or storage area/hatch. This makes it difficult to reach into the vehicle and while at an extended position of the arms, to lift up the somewhat heavy battery pack. Therefore, the extending arm allows for easier access by moving the battery pack to an edge of the vehicle trunk/storage space, out of it and away from the vehicle, or out of the vehicle and down to the ground, in varying embodiments. In particular embodiments, the arm may be a sliding or telescoping arm. Movement of the arm and battery pack may be aided by springs, pistons, a motor, and the like. Bearings, wheels, casters, greased surfaces, and low friction materials may all aid in the extending motions, such as telescoping and the like.

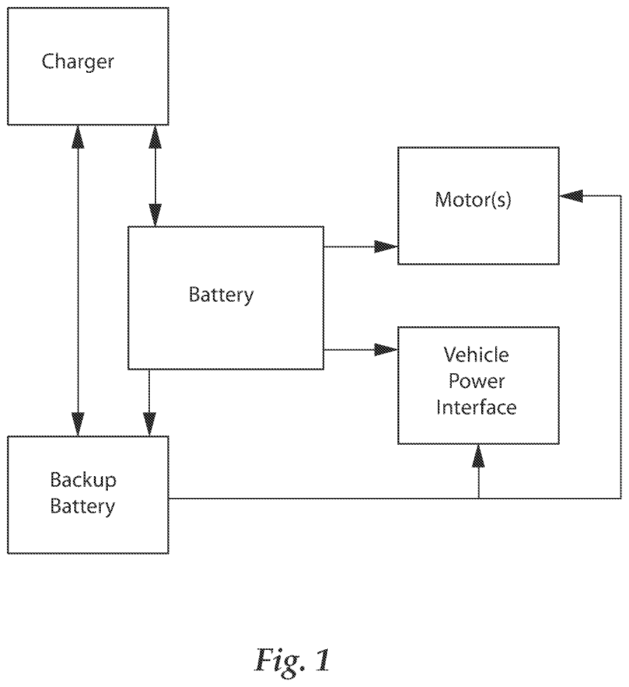

Turning now to FIG. 1 a schematic chart of an embodiment of electrical communication of vehicle components is shown. In this view, a charge port is in electric direct communication with the primary battery as well as the backup battery. As such, charge can flow, selectively in some embodiments, directly to the primary and backup battery at the same time. The primary battery is also able to charge the backup battery in this embodiment, however the backup battery does not charge the primary battery. The primary battery is operable to provide power to the motor or motors of the EV, as well as providing electricity to the vehicle power interface (which includes vehicle computer, controls, climate control, and so forth). The backup battery, when activated by a switch, is also able to provide power to the motor or motors of the EV, as well as providing electricity to the vehicle power interface. As such, the backup battery is able to power the vehicle for a short period of time to allow it to travel to a nearby charging station or other electricity source. As can be envisioned, the backup battery has a capacity that is less-often significantly less, than the primary battery, and is used solely in emergency situations to allow the vehicle to “limp” to a charging station.

In many cases, performance ability such as top speed and acceleration rate are limited by the computer controller when using the backup battery so as to maximize range. For example, a top speed may be limited to 45, 50, or 55 mph in some embodiments. In additional embodiments, acceleration rate may be reduced to approximately 25%, 33%, 40%, 50%, 75% of maximum, depending on embodiment by, for example limiting a maximum electrical flow rate to the motor or motors. In still further embodiments, when using the backup battery, a vehicle having more than one motor may be operable to have the backup battery power only one of the multiple motors to conserve energy.

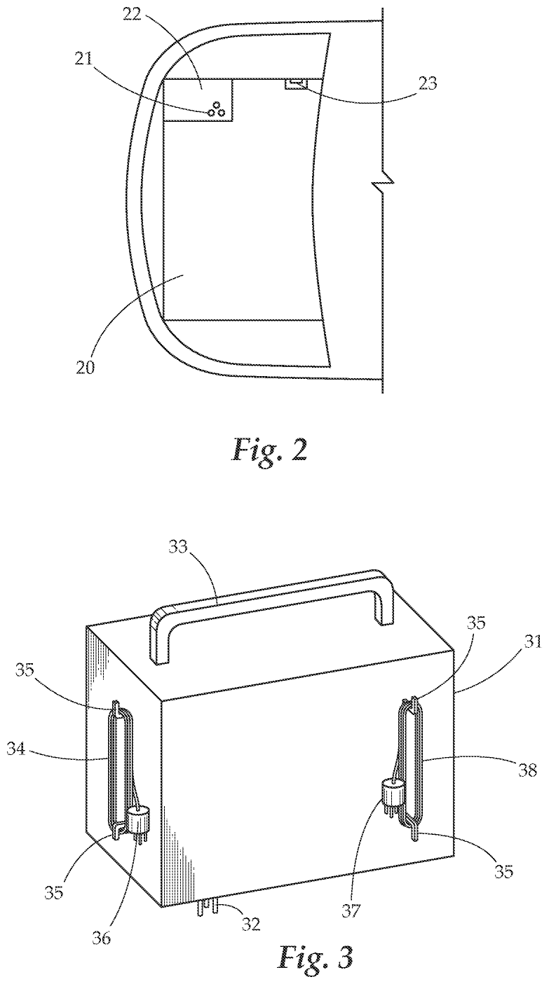

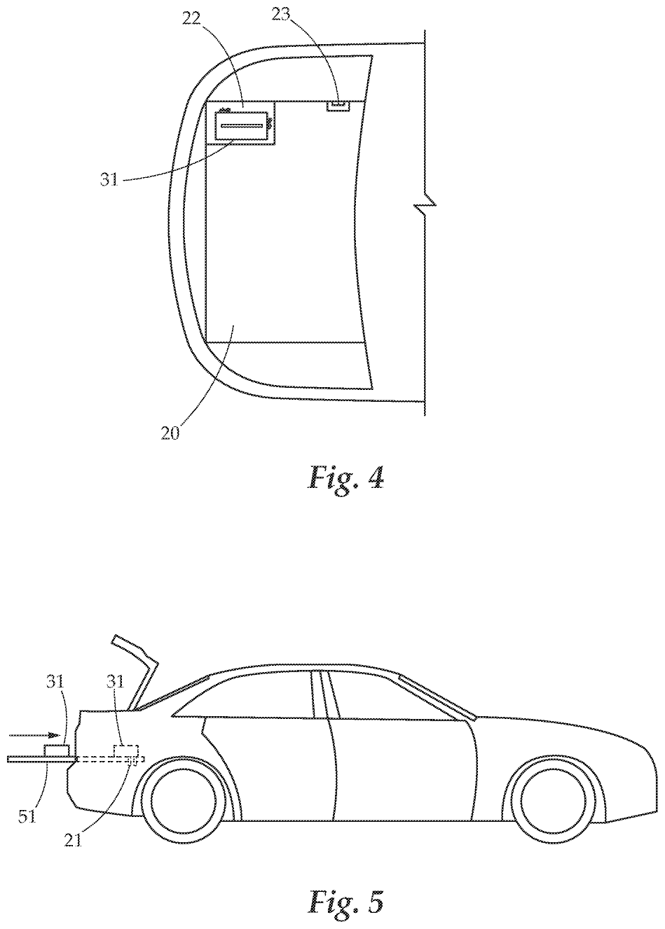

FIGS. 2 and 4 show an embodiment of an EV of the present disclosure having a well which is defined in the trunk of the vehicle to receive and store a removable backup battery pack. The well 22 is formed in the trunk 20 of the EV 1 and is sized to receive the backup battery pack (shown in FIG. 4). Within the well 22 is a plug 21 which engages with a corresponding plug of the backup battery. As such, the backup battery can be removably positioned into the well 22 of the EV's trunk 20, and can be securely held there during normal operation of the vehicle as well as when using the backup battery as an emergency backup source to reach a charging location. Further, a switch 23 within the trunk 20 is accessible to manually activate the backup battery and allow it to operate the vehicle, rather than relying on the primary battery. As noted above, the manual switch provides certain advantages in some cases that are not available with an electronically or computer controlled switch.

FIG. 3 provides a view of an embodiment of the removable backup battery pack. The backup battery 31 is enclosed in a case, and has a handle 33 allowing easy lifting and carrying. The backup battery, in this embodiment, is able to connect to a standard wall plug as a source of charging. Accordingly, cable stays 35 hold a cable 38 and plug 37, shown here as a standard wall plug, in a wrapped position. The backup battery is also able to charge a second EV other than the one in which it is intended to be connected. In this embodiment, the backup battery has a cord 34 extending from the battery having a plug connector 36 operable to connect to an EV through its charge port, such as a J1772 plug and the like. The cord 34 can be held neatly in place using, in this embodiment, cable stays 35 to wrap the cord. An electrical connector 32 is positioned on a bottom of the battery 31 case and allows the backup battery to connect to the electric plug within the vehicle storage area, such as plug 21 shown in FIG. 2. This allows direct connection of the battery to the vehicle, without the need for a plug connection to the charge port of the EV.

FIG. 5 shows a view of an extending arm which allows the backup battery pack to slide, via the arm, between an engaged position within the vehicle and electrically connected to the EV, and an extended position outside of the vehicle and away from the vehicle body. The backup battery 31 is shown in solid lines in its engaged position having its electrical connector (not shown) engaged with the vehicle electrical connector 21. The backup battery 31 is in the trunk of the EV in the engaged position, towards a rear corner of the trunk, to best prevent it interfering with cargo storage. Arm 51 is also shown in solid lines within the trunk. In broken lines, the arm 51 and backup battery 31 are shown in the extended position. Arm 51 may be any structure which can allow sliding or telescoping extension of the backup battery. In one embodiment, the arm 51 may be a telescoping arm which allows the telescoping components to extend outwardly with the backup battery 31 thereon. A pushing motion may then retract the arm telescoping components into each other. In a particular embodiment, this pushing motion may also load a spring, piston, elastic tensioner and the like so that the movement from engaged to extended position may be aided in a controlled manner. In another embodiment, the arm 51 may be formed as a track which allows the battery 31 to slide along it. In one embodiment, the backup batter 31 need not extend out or away from the vehicle in the extended position, it may just be movable to the edge of the trunk/vehicle storage area so that it is more easily accessible than if it were in the back of the trunk such that a user would have to extend his or her arms to reach in and lift at an uncomfortable angle.

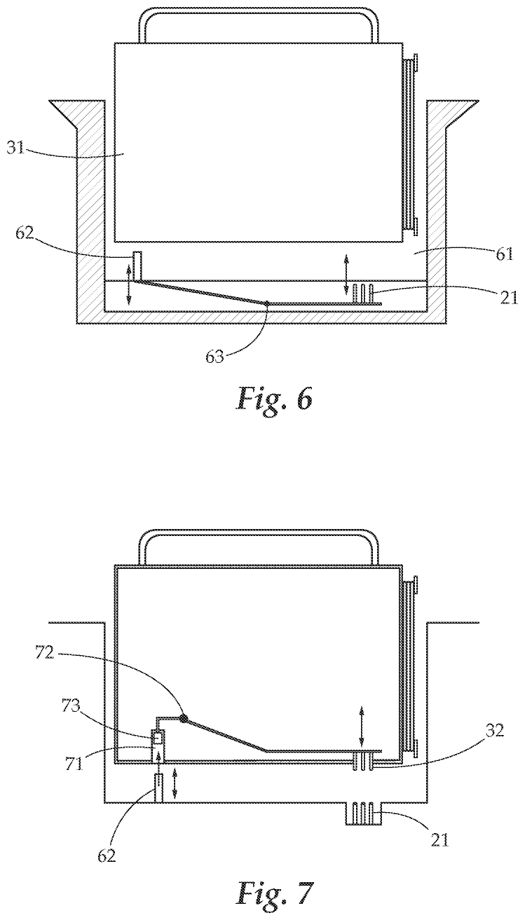

FIG. 6 provides a detail cutaway view of an embodiment of the backup battery 31 engaging with the EV well/storage area. Here, battery pack 31 fits into a well 61 (which may be the same or different from well 22 shown in the previous figures) in the trunk of the EV. The backup battery 31 has a female plug electrical connector engagable with a male plug electrical connector of the EV. When engaged, the backup battery pack 31 pushes protrusion 32 downward which urges connector 21 upward into engagement with the female electrical connector in the backup battery 31 via pivoting arm 63. Upon removing the backup battery 31 from its position in the well 61, the connector 21 falls downward and disconnects, while protrusion 62 moves upward. In this embodiment, the well 61 and/or battery pack 31 may have a snap-fit arrangement that allows the two to engage securely, and also allows the battery pack 31 to be removed upon a sufficient application of force against the snap fit.

FIG. 7 provides a detail cutaway view of an embodiment of the backup battery 31 engaging with the EV well/storage area. Here, battery pack 31 fits into a well 61 in the trunk of the EV. The backup battery 31 has a male plug electrical connector 32 engagable with a female plug electrical connector 21 of the EV. In this embodiment, protrusion 62 is fixed to the well 61 and extends upwardly therefrom. The protrusion is sized to engage with a slot 71 in the backup battery pack 31. A plunger 73 is slidable in the slot 71 and when the backup battery 31 is placed into he well 61, its weight causes protrusion 62 to push plunger 73 upwardly. In turn, the upward motion by plunger 73 causes the male plug 32 out away from the backup battery 31 case via pivoting arm 72, such that it can engage with plug 21 of the EV.

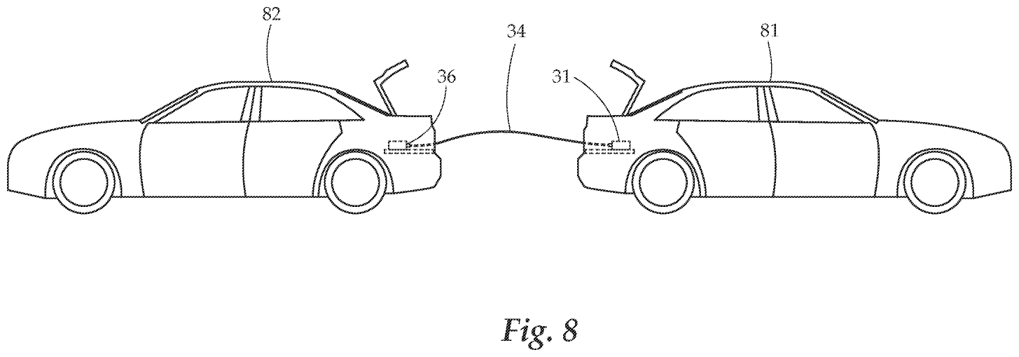

FIG. 8 provides a view of an embodiment of the backup battery being used to charge a second different EV from the EV it is installed in via a charging cable connected to the second EV's charge port. Here, the first EV 81 has the backup battery 31 engaged in its trunk or other storage area. A cord 34 of the backup battery 31 is connected to second EV 82 via a plug 36, such as a J1772 plug or other connector, which is engaged with the charge port of the second EV 82.

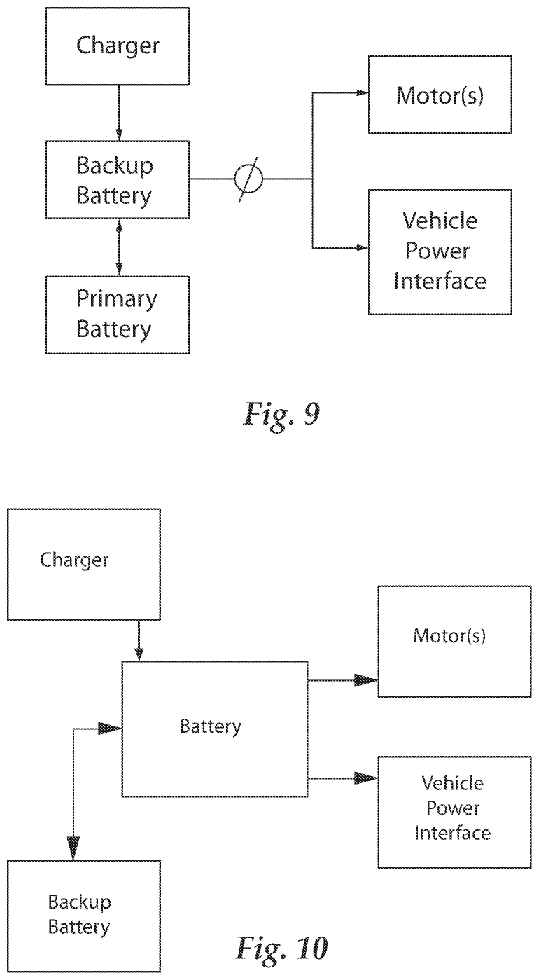

FIG. 9 provides a schematic chart of an embodiment of electrical communication of vehicle components is shown. In this view, a charge port is in electric direct communication with the backup battery, and then the primary battery in a chain. As such, charge flows first to the backup battery and, once the backup battery reaches a certain state of charge, to the primary battery. The primary battery is able to charge the backup battery in this embodiment, and also the backup battery may charge the primary battery. The primary battery is operable to provide power to the motor or motors of the EV, as well as providing electricity to the vehicle power interface (which includes vehicle computer, controls, climate control, and so forth). The backup battery, when activated by a switch, is also able to provide power to the motor or motors of the EV, as well as providing electricity to the vehicle power interface. As such, the backup battery is able to power the vehicle for a short period of time to allow it to travel to a nearby charging station or other electricity source. As can be envisioned, the backup battery has a capacity that is less, often significantly less, than the primary battery, and is used solely in emergency situations to allow the vehicle to “limp” to a charging station.

FIG. 10 provides a schematic chart of an embodiment of electrical communication of vehicle components is shown. In this view, a charge port is in electric direct communication with the primary battery, and then the backup battery in a chain. As such, charge flows first to the primary battery and, once the primary battery reaches a certain state of charge, to the backup battery. The primary battery is able to charge the backup battery in this embodiment, and also the backup battery may charge the primary battery. The primary battery is operable to provide power to the motor or motors of the EV, as well as providing electricity to the vehicle power interface (which includes vehicle computer, controls, climate control, and so forth). The backup battery, when activated by a switch, is operable to provide charge to the primary battery, which in turn can operate the vehicle once sufficiently charged by the backup battery. As such, the backup battery is able to provide power for the vehicle for a short period of time by charging the primary battery to allow it to travel to a nearby charging station or other electricity source.

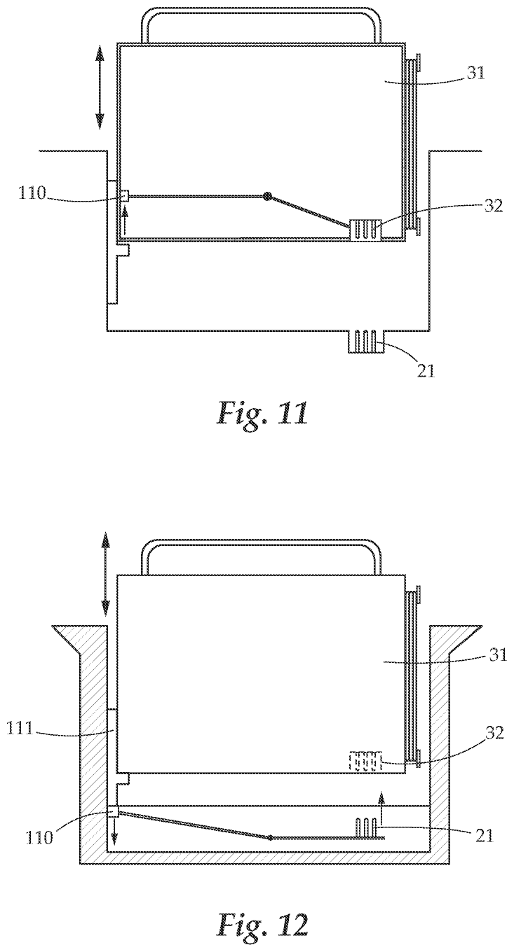

FIG. 11 provides a detail cutaway view of an embodiment of the backup battery 31 engaging with the EV well/storage area. Here, backup battery 31 fits into the well 61 or similar storage space of the EV by sliding into it. The backup battery 31 has a male plug electrical connector 32 which is retractable and extendable from the battery case. The well 61 has guide slots or rails 112 to engage with the battery 31 and guide it into position. A tab 111 extends from one of the guide slots and engages with a catch 110 on the backup battery 31. Movement of this catch 110 as the battery is guided into proper resting position at the bottom of the well 61 causes the male plug 32 to extend away from the backup battery to be able to engage with matching female plug 21 of the EV.

FIG. 12 provides a detail cutaway view of an embodiment of the backup battery 31 engaging with the EV well/storage area. Here, backup battery 31 fits into the well 61 or similar storage space of the EV by sliding into it. The backup battery 31 has a female plug electrical connector 32, while the EV has a retractable male plug 21 which is retractable and extendable from the bottom of well 61. The well 61 has guide channels or rails 112 to engage with the battery 31 and guide it into position. A movable tab 111 extends from one of the guide channels and engages with a catch 110 on the backup battery 31. Movement of this tab 111 as the battery is guided into proper resting position at the bottom of the well 61 causes the male plug 21 to extend away from the well 61 towards the backup battery 31 to be able to engage with matching female plug 32 of the backup battery 31.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1) An electric vehicle comprising:
a frame;
a body connected to the frame and defining an interior space for passengers;
a plurality of wheels;
a storage space defined by the body at least partially separated from the interior space for passengers;
a primary battery connected to at least one of the frame and the body, the primary battery being in electrical communication with at least one motor operable to rotate at least one of the plurality of wheels;
a charge port operable to receive an electrical connection to charge the primary battery; and
a backup battery, the backup battery having a charge capacity that is less than a charge capacity of the primary battery, the backup battery comprising:
a case on an outside of the backup battery;
an electrical connector allowing an electronic communication of the backup battery with the electric vehicle;
a cord extending from the case, the cord allowing connection of the backup battery with a second different vehicle to charge a battery of the second different vehicle;
wherein the backup battery is removably connectable in the storage space, when in a connected position, the backup battery electrical connector engaged with a corresponding electrical connector in the vehicle storage space, the corresponding vehicle electrical connector in electronic communication with at least one of the primary battery and the at least one motor to cause a rotation of at least one of the plurality of wheels;
a switch operable to allow electric flow from the backup battery to at least one of the primary battery and the at least one motor; and
a vehicle computer operable to monitor a state of charge of the primary battery and a state of charge of the backup battery and operable to provide an output on a display relating to the state of charge of the primary battery and the state of charge of the backup battery.

2) The vehicle of claim 1 wherein the backup battery is removably connected in a well formed into the storage space.

3) The vehicle of claim 1 wherein the electrical connector of the backup battery is retractable into the case of the backup battery and movable between a retracted position and extended position, the electrical connector biased in the retracted position until connected to the vehicle.

4) The vehicle of claim 3 wherein the storage space defines a protrusion engageable with the backup battery, the protrusion causing the retractable electrical connector to move to the extended position.

5) The vehicle of claim 1 wherein the electrical connector of the vehicle engagable with the backup battery is retractable into a panel of the storage space, and movable between a retracted position and extended position, the electrical connector biased in the retracted position until the backup battery is connected to the vehicle.

6) The vehicle of claim 5 wherein the backup battery defines a protrusion engageable with the vehicle, the protrusion causing the retractable electrical connector to move to the extended position.

7) The vehicle of claim 1 wherein the switch is a manual switch positioned in the storage space requiring physical actuation by a user.

8) The vehicle of claim 1 wherein the vehicle computer is operable to first charge the backup battery to approximately 100% state of charge when an electricity source is plugged into the charge port before charging the primary batter.

9) The vehicle of claim 1 wherein the vehicle computer is operable to direct electricity from the primary battery to the backup battery to charge the backup battery to approximately 100% state of charge when the state of charge of the backup battery drops below a predetermined level.

10) The vehicle of claim 1 wherein the backup battery directly powers the at least one motor as controlled by the vehicle computer upon actuation of the switch.

11) The vehicle of claim 1 wherein the vehicle comprises a plurality of motors, and wherein the backup battery directly powers only one of the plurality of motors as controlled by the vehicle computer upon actuation of the switch.

12) The vehicle of claim 1 wherein the backup battery directly charges the primary battery upon actuation of the switch.

13) The vehicle of claim 1 wherein the backup battery is stored within a well defined by the storage space and further comprising a cover at least partially surrounding the case of the backup battery, the cover holding the backup battery in position.

14) The vehicle of claim 1 wherein the case of the backup battery and the storage space each define a channel or guide to interface with each other.

15) The vehicle of claim 1 wherein the storage space defines a base which is formed so as to allow a snap fit of the case of the backup battery into a secure position in the storage space.

16) The vehicle of claim 1 wherein the battery is connected to a retracting arm, the retracting arm movable between an engaged position having the backup battery electronically connected to the vehicle, and an extended position having the backup battery extending away from the vehicle.

17) The vehicle of claim 16 wherein the retracting arm is slideably extendable.

18) The vehicle of claim 16 further comprising a piston operable to control a movement of the retracting arm between the engaged and extended position.

19) The vehicle of claim 16 wherein the extended position of the retracting arm is at a position below the engaged position.

20) A method of operation of an electric vehicle backup battery comprising the steps of:
charging the backup battery using a wall outlet, the backup battery having a cord and plug for connection of the battery to the wall outlet;
positioning the backup battery into an electric vehicle, the step of positioning the backup battery comprising engaging an electrical connector of the backup battery with an electrical connector of the electric vehicle positioned within the electric vehicle;
removing the backup battery from the electric vehicle; and
charging a second different electric vehicle using the backup battery by connecting a charging cord of the backup battery to a charge port of the second different electric vehicle.
